(19) United States
(12) Patent Application Publication
(10) Pub. No.: US 2009/0319879 A1
(43) Pub. Date: Dec. 24, 2009

(54) Double click inline edit / single click action

(76) Inventors: Jeffrey Scott, San Clement, CA (US); Diane Cochran, Mission Veijo, CA (US); Miranda Ragland, Long Beach, CA (US)

Correspondence Address: DUANE MORRIS LLP - San Diego, 101 WEST BROADWAY, SUITE 900, SAN DIEGO, CA, 92101-8285, US

(21) Appl. No.: 12/288,489

(22) Filed: Oct. 20, 2008

Related U.S. Application Data
(60) Provisional application No. 60/999,659, filed on Oct. 19, 2007.

(51) Int. Cl. G06F 17/00

(52) U.S. Cl. 715/205

(57) ABSTRACT

A system, method and prepaid payment card configured to enable web-browser behavior for double-click in-line edit and single click action fields.

### RELATED APPLICATIONS

This application claims priority to U.S. Provisional Patent Application No. 60/999,659, entitled DOUBLE CLICK INLINE EDIT/SINGLE CLICK ACTION, filed Oct. 19, 2007.

### BACKGROUND

1. Field of the Invention

Aspects of the present invention relate in general to user-interfaces. Aspects include an apparatus, system, method and computer-readable medium to enable web-browser behavior for double-click in-line edit and single click action fields.

2. Background of the Invention

In March, 1989, the European Laboratory for Particle Physics or CERN (Conseil Europeen pour la Recherche Nucleaire) developed the World-Wide-Web (WWW, or simply, “the web”), an Internet-based computer network that allows users on one computer to access information stored on other computers through a world-wide network. With an intuitive user-interface, known as a web browser, the web rapidly became a popular way of transmitting and accessing text and binary information. Since then, there has been a massive expansion in the number of World-Wide-Web sites, and the amount of information placed on the web.

The web is built on a very simple, but powerful premise. All material on the web is formatted in a general, uniform format called HTML (Hypertext Markup Language), and all information requests and responses conform to a similarly standard protocol. When someone accesses a server on the Web, such as the Library of Congress, the user's Web browser will send an information request to the Library of Congress' computer. This computer is called a web server. The web server will respond to the request by transmitting the desired information to the user's computer. There, the user's browser will display the received information on the user's screen.

Hypertext documents (also known as “web pages”) contain links to other web pages. Users may navigate from one page to another by “clicking” on an underlined hypertext link.

### BRIEF DESCRIPTION OF THE DRAWINGS

FIG. 1 illustrates a web-browser embodiment configured to enable an in-line edit or an action through a single click on the same field.

FIG. 2 is a block diagram of an apparatus configured to enable an in-line edit or an action through a single click on the same field.

FIG. 3 is a black diagram of an apparatus configured to enable an in-line edit or an action through a single click on the same field.

FIG. 4 is a state diagram of a method configured to enable an in-line edit or an action through a single click on the same field.

### DETAILED DESCRIPTION

One aspect of the present invention includes a web-page configured to enable an in-line edit or an action through a single click on the same field.

Embodiments of the present invention include an apparatus, method and computer-readable media that enable an in-line edit or an action through a single click on the same field.

The following terminology is used to describe the embodiments of the present invention. It is understood that others may use similar terms to describe other various embodiments.

Inline Edit: A hybrid state that allows a field value to be edited while its containing form is in its view state.

Single Click Action: The action or event that is associated with a single click on the field's value.

Double Click Action: The action or event that is associated with a double click on the field's value.

Protected Field: Any field which is not allowed to be directly edited by the user.

An embodiment will be described as a web application. It is understood that other embodiments may exist and that any implementation specific details may vary. Furthermore, the embodiment described below is implemented in JavaScript. It is understood by those familiar with the art that other languages may be used. Some platforms, notably Internet Explorer, support multiple scripting languages. Because the browser event model is in theory language agnostic it is not to be assumed that JavaScript is the only language in which this technique can be implemented.

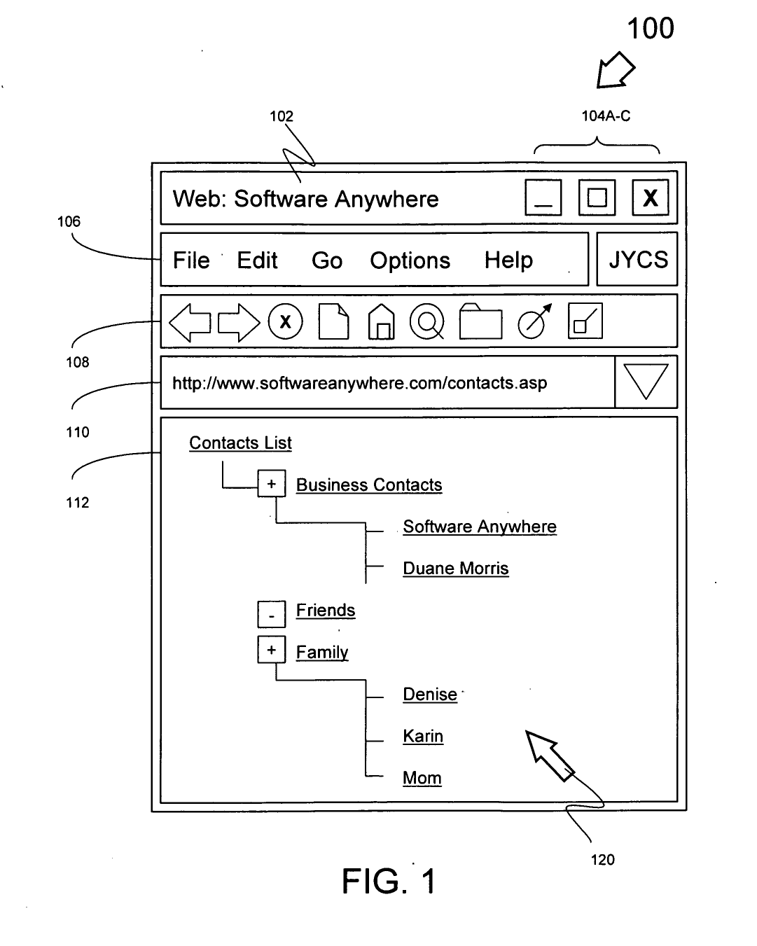

An example of such a web application in a web browser window is shown in FIG. 1, constructed and operative in accordance with an embodiment of the present invention. Web browser window 100 comprises title bar 102, window control buttons 104A-C, menu bar 106, button bar 108, address bar 110, window content frame 112, and mouse pointer 120.

In these embodiments, window content frame 112 displays content from the web-application, this may include forms and editable fields. In this example, the forms depicted are a user's contacts list, but it is understood that other types of forms may be used. In the embodiment system, forms have multiple primary states: view, edit, and design. When a form is in edit state all fields, with the exception of protected fields, are presented with their appropriate input control and editing is allowed. When a form is in view state all fields are presented in a non editable state. While a form is in the view state it is possible to allow a single field, not the entire form, to enter its edit state by double clicking on the field value, when this occurs the field has entered the Inline Edit state. Like in the form's edit state, Inline Edit is only enabled for non protected fields. The Inline Edit state is triggered by an event handler for the double click event.

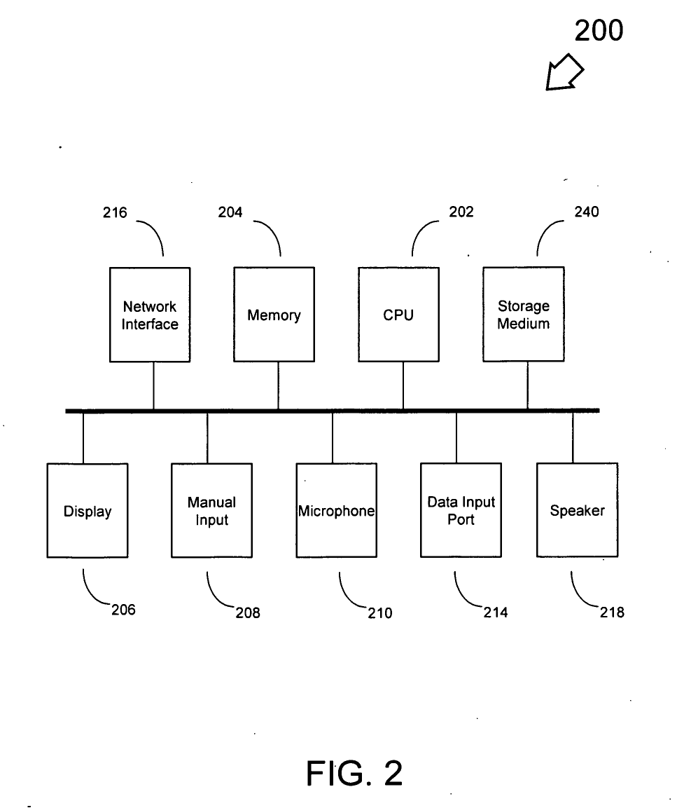

Embodiments will now be disclosed with reference to a functional block diagram of an exemplary an in-line edit or an action device 200 of FIG. 2, constructed and operative in accordance with an embodiment of the present invention. Device 200 may run a multi-tasking operating system (OS) and include at least one processor or central processing unit (CPU) 202. Processor 202 may be any microprocessor or micro-controller as is known in the art.

The software for programming the processor 202 may be found at a computer-readable storage medium 240 or, alternatively, from another location across a network via the world-wide-web. Processor 202 is connected to computer memory 204. Device 200 may be controlled by an operating system that is executed within computer memory 204.

Processor 202 communicates with a plurality of peripheral equipment, including network interface 216. Additional peripheral equipment may include a display 206, manual input device 208, storage medium 240, microphone 210, and data port 214.

Display 206 may be a visual display such as a cathode ray tube (CRT) monitor, a liquid crystal display (LCD) screen, flat-panel display, touch-sensitive screen, or other monitors as are known in the art for visually displaying images and text to a user.

Manual input device 208 may be a conventional keyboard, keypad, mouse, trackball, joystick, light pen, areas of a touch-sensitive screen or other input device as is known in the art for the manual input of data.

Storage medium 240 may be a conventional read/write memory such as a magnetic disk drive, floppy disk drive, compact-disk read-only-memory (CD-ROM) drive, digital versatile disk (DVD) drive, flash memory, memory stick, transistor-based memory or other computer-readable memory device as is known in the art for storing and retrieving data. Significantly, storage medium 240 may be remotely located from processor 202, and be connected to processor 202 via a network 110 such as a local area network (LAN), a wide area network (WAN), or the Internet.

Microphone 210 may be any suitable microphone as is known in the art for providing audio signals to processor 202. In addition, a speaker 218 may be attached for reproducing audio signals from processor 202. Video input 122 may be a digital or analog video camera device to record still or moving images. It is understood that microphone 210, speaker 218, and data port 214 may include appropriate digital-to-analog and analog-to-digital conversion circuitry as appropriate.

Data port 214 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 214 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, data port 214 may consist of a modem connected to network interface 216. Similarly, in some embodiments network interface 216 provides connectivity to device 200 to communicate with a network 110. Thus, the network interface 216 allows the device 200 to communicate and process input and output from across a network.

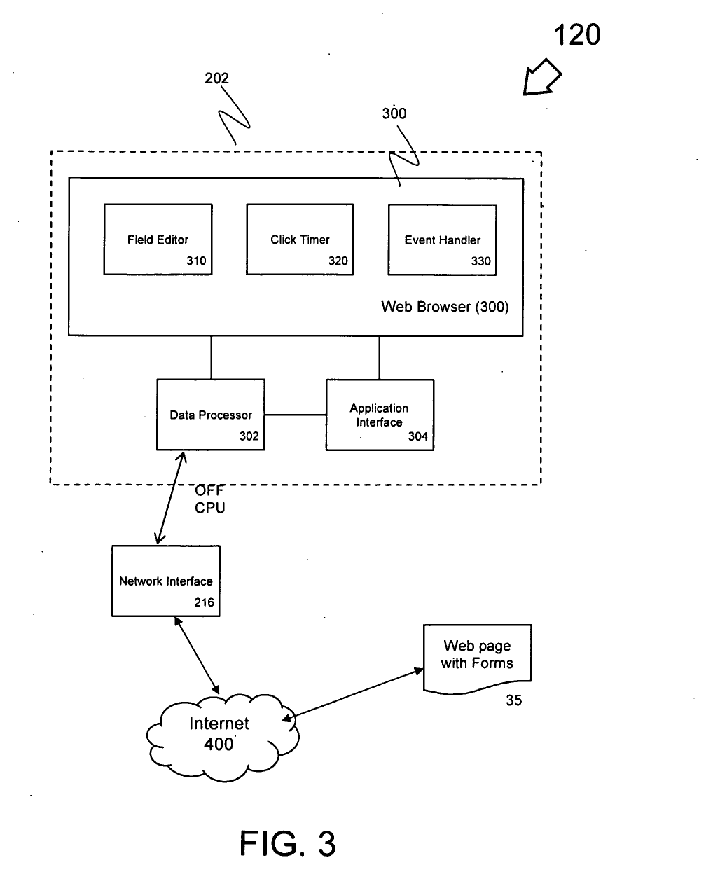

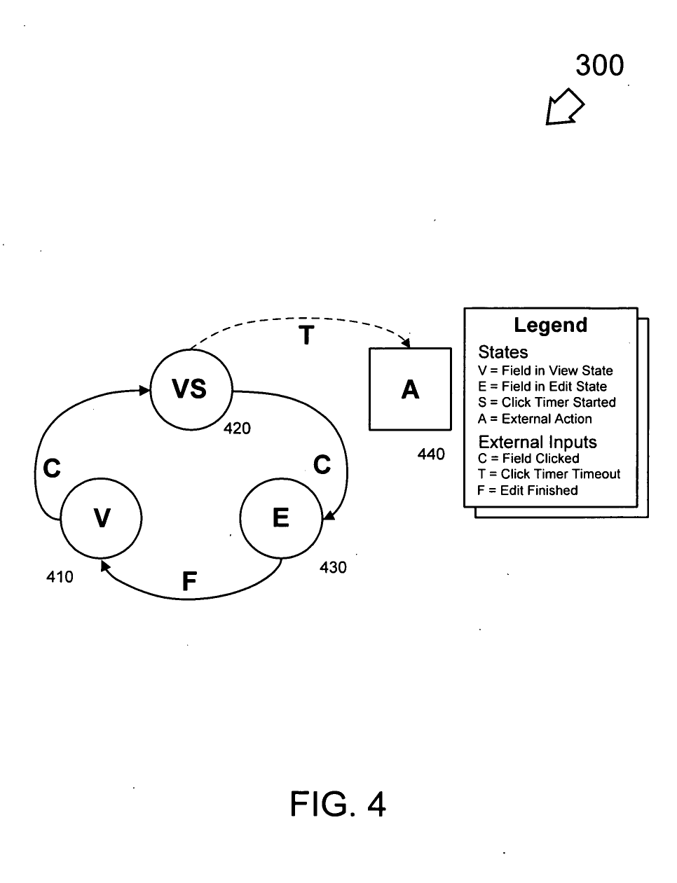

FIG. 3 is an expanded functional block diagram of processor 202 accessing a web page with forms 350 over the internet 400 via a network interface 216, constructed and operative in accordance with an embodiment of the present invention. It is well understood by those in the art, that the functional elements depicted within processor 202 may be implemented in hardware, firmware, or as software instructions and data encoded on a computer-readable storage medium 240. As shown in FIG. 3, processor 202 is functionally comprised of a web browser 300, data processor 302, and an application interface 304. Web browser 300 may further comprise: field editor 310, click timer 320, and event handler 330. These structures may be implemented as hardware, firmware, or software encoded on a computer readable medium, such as storage media 240. The function of these structures may best be understood with respect to the state diagram of FIG. 4, as described below.

Data processor 302 interfaces with display 206, manual input device 208, storage medium 240, microphone 210, data port 214, and network interface 216. The data processor 302 enables processor 202 to locate data on, read data from, and write data to, these components.

Application interface 304 enables processor 202 to take some action with respect to a separate software application or entity. For example, application interface 304 may take the form of a windowing call recipient interface, as is commonly known in the art.

As shown, the in-line editing system 300 may be part of a web-browser. However, in some embodiments, in-line editing system 300 may be stand-alone program, or a subset of a web-browser window or browser plug-in.

FIG. 4 depicts process 300, a method of in-line editing or triggering an action, constructed and operative in accordance with an embodiment of the present invention.

Fields that may have an action 440 associated with the click event register an onclick event handler 330. Fields that typically have an action associated with them are lookup relationships, state 420. In the view state 410 of a lookup relationship a hyper-link is provided that links to the target. The onclick event handler 330 is used for every click action by the user regardless if the click is from a double click. This creates a scenario where a user tries to enter Inline Edit 430 but ends up triggering the single click action. In some situations this could possibly be desirable, but when a hyper-link is involved the Inline Edit trigger will effectively never be triggered.

The Solution

The event handler 330 for the single click event can be restructured to not immediately trigger the single click action. Instead a callback function can be attached to timer 320, called “clickTimer,” such that the function will be called once the timeout has expired. The click handler 330 can distinguish between a single click and a double click by whether or the clickTimer is set. Once a double click has been detected the click timer 320 needs to be stopped to prevent the timeout.

Pseudocode Implementation

The following is a pseudo code implementation of an embodiment of the present invention.

global Timer clickTimer = null;
global int clickTimeout = 500;
function clickEventHandler( ) {

if (clickTimer == null) {

clickTimer = newTimer( );
clickTimer.setTimeoutCallback(singleClickAction);
clickTimer.setTimeout(clickTimeout);
clickTimer.start( );

} else {

clickTimer.stop( );
clickTimer = null;
call doubleClickAction;

}

}
function singleClickAction( ) {

// action code goes here

}
function doubleClickAction( ) {

// action code goes here

}

Other Uses

The technique above was developed specifically for the Double Click In-place Edit/Single Click Action issue, however, it is not the only potential use. The technique is applicable to all cases where an item requires two different actions to be performed based upon whether the user used a single click, or double click. Some potential example uses are provided below.

Email addresses are often provided as a hyperlink, using the mailto: protocol, that will open up the end users default email application with the email address set as the To: address. A field that contains an email address could trigger the hyperlink as the single click action. The double click action could trigger a search of records containing references to the given email address.

A reference to an external site or page is often given as a hyperlink. The hyperlink provides the single click action and will open in the current window, provided that the link is not set to open in a new window. The double click action could modify the link to allow it to open in a new window. This gives the user the option of either opening the link in the same browser window, or opening it in an entirely new window so that it will be available for reference but the user can still work in the primary site.

A hyperlink could also use the technique above to provide two separate targets. An example where this could be desirable is in the Embodiment system a list of records is provided. The list could be modified such that a hyperlink is provided. The hyperlink's single click action could direct the user to the records view form, and the double click action could direct the user to the records edit form. This is very similar to the issue the technique was developed for but it differs in that it operates at the full form level rather than the field level.

Media files such as pictures, audio, or video can setup such that the single click action would display/play the file and the double click action would trigger a download of the file.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein

What is claimed is:

1. An apparatus to handle a data field, comprising:
an event handler configured to receive a first click on the data field;
a click timer configured to start a timer when the first click occurs; and
the click handler is further configured to wait for a second click on the data field before the timer times out, to perform a first action if the timer times out; and to perform a second action when the second click on the data field occurs before the timer times out.

2. The apparatus of claim 1 wherein the data field is a hyperlink

3. The apparatus of claim 2 wherein the first action is accessing the hyperlink.

4. The apparatus of claim 3 wherein the second action is a search of records containing references to the hyperlink.

5. The apparatus of claim 3 wherein the second action allows a user the option of opening the hyperlink in a new browser window displayed on a display device.

6. The apparatus of claim 3 wherein the second action opens the hyperlink in a new browser window on a display device.

7. The apparatus of claim 3 wherein the second action allows a user to edit a field of the hyperlink on a display device.

8. The apparatus of claim 3 wherein the first action enables playing of a media file on a display device or a speaker.

9. The apparatus of claim 8 wherein the second action enables a download of a media file to a storage medium.

10. A method of handling a data field, comprising:
receiving a first click on the data field;
starting a timer;
waiting for a second click on the data field before the timer times out;
performing a first action if the timer times out; and
performing a second action when the second click on the data field occurs before the timer times out.

11. The method of claim 10 wherein the data field is a hyperlink

12. The method of claim 11 wherein the first action is accessing the hyperlink.

13. The method of claim 12 wherein the second action is a search of records containing references to the hyperlink.

14. The method of claim 12 wherein the second action allows a user the option of opening the hyperlink in a new browser window displayed on a display device.

15. The method of claim 12 wherein the second action opens the hyperlink in a new browser window on a display device.

16. The method of claim 12 wherein the second action allows a user to edit a field of the hyperlink on a display device.

17. The method of claim 12 wherein the first action enables playing of a media file on a display device or a speaker.

18. The method of claim 17 wherein the second action enables a download of a media file to a storage medium.

19. A computer-readable medium, encoded with data and instructions, such that when executed by a computer, the instructions causes the computer to:
receive a first click on the data field;
start a timer;
wait for a second click on the data field before the timer times out;
perform a first action if the timer times out; and
perform a second action when the second click on the data field occurs before the timer times out.

20. The computer-readable medium of claim 19 wherein the data field is a hyperlink
